(19) United States
(12) Patent Application Publication
(10) Pub. No.: US 2018/0363684 A1
(43) Pub. Date: Dec. 20, 2018

(54) NOZZLE ASSEMBLY

(71) Applicant: Hamilton Sundstrand Corporation, Charlotte, NC (US)

(72) Inventors: Piotr KOZLOWSKI, Mielec (PL); Piotr SAWICKI, Bogdaniec (PL)

(21) Appl. No.: 15/964,152

(22) Filed: Apr. 27, 2018

(30) Foreign Application Priority Data
Jun. 19, 2017 (EP) 17461549.2

(51) Int. Cl. F15B 13/043; F15B 19/00; F15C 3/14

(52) U.S. Cl. CPC F15B 13/0438; F15C 3/14; F15B 19/002

(57) ABSTRACT

A nozzle assembly (N) comprises a nozzle received in a nozzle receiving bore of a nozzle housing. The nozzle receiving bore has a longitudinal axis (X-X). The nozzle housing further comprises a locking pin receiving bore having a longitudinal axis (Y-Y) that is perpendicular to the nozzle housing axis (X-X). The locking pin receiving bore intersects the nozzle receiving bore, whereby an aperture is formed between the locking pin receiving bore and the nozzle receiving bore. A locking pin is received in the locking pin receiving bore, a portion of the locking pin protruding through the aperture and into the nozzle receiving bore so as to engage a circumferential portion of the nozzle.

### FOREIGN PRIORITY

This application claims priority to European Patent Application No. 17461549.2 filed Jun. 19, 2017, the entire contents of which is incorporated herein by reference.

### TECHNICAL FIELD

This disclosure relates to a nozzle assembly, and more specifically, but not exclusively, to a nozzle assembly of a servo valve.

This disclosure also relates to a servo valve, a method of assembling a nozzle assembly and a method of calibrating a nozzle assembly.

### BACKGROUND

Servo valves are well-known in the art and can be used to control how much fluid is ported to an actuator. Typically, a flapper is deflected by an armature connected to an electric motor away or towards nozzles, which inject the fluid. Deflection of the flapper can control the amount of fluid injected from the nozzles, and thus the amount of fluid communicated to the actuator. In this way, servo valves can allow precise control of actuator movement. Calibration of the servo valve is often required to ensure the correct control of actuator movement is realised, and is achieved by adjusting the axial distance from the nozzle outlet to the flapper.

Typically, the nozzles are interference fitted into a nozzle housing. The interference fit of the nozzle into the housing has to be very tight to ensure that it remains in the correct position within the housing at all operating temperatures. This tight fit can make it difficult to calibrate the servo valve, as it may make it difficult to move the nozzle axially within the nozzle housing.

### SUMMARY

From one aspect, the present disclosure relates to a nozzle assembly in accordance with claim 1.

In one embodiment of the above nozzle assembly, the nozzle is received with an interference fit within the nozzle receiving bore.

In a further embodiment of any of the above nozzle assemblies, the locking pin is received with a close or loose fit in the locking pin receiving bore.

In a further embodiment of any of the above nozzle assemblies, the nozzle receiving bore is cylindrical.

In a further embodiment of any of the above nozzle assemblies, the locking pin receiving bore is cylindrical.

In a further embodiment of any of the above nozzle assemblies, the locking pin receiving bore is a through bore.

In a further embodiment of any of the above nozzle assemblies, the nozzle receiving bore is circular in cross section. In addition or alternatively, the locking pin receiving bore is circular in cross section.

In a further embodiment of any of the above nozzle assemblies, the nozzle is circular in cross section. In addition or alternatively, the locking pin is circular in cross section.

In a further embodiment of any of the above nozzle assemblies, the nozzle is provided with a threaded connection at one end for connection to a calibration tool.

In a further embodiment of any of the above nozzle assemblies, the nozzle receiving bore receives a pair of opposed nozzles.

From another aspect, the present disclosure relates to a servo valve comprising the nozzle assembly of any of the above embodiments.

From yet another aspect, the present disclosure relates to a method of assembling a nozzle assembly in accordance with claim 12.

From yet another aspect, the present disclosure relates to a method of calibrating a nozzle assembly in accordance with claim 13.

In one embodiment of the above method, the nozzle is received in the nozzle receiving bore with an interference fit.

In a further embodiment of any of the above methods of calibrating a nozzle assembly, the nozzle is inserted or moved in the nozzle receiving bore by a tool engaging an end of the nozzle.

### BRIEF DESCRIPTION OF DRAWINGS

Some exemplary embodiments of the present disclosure will now be described by way of example only, and with reference to the following drawings in which:

FIG. 1 shows an example of a prior art servo valve;

FIG. 2a shows a perspective cross-sectional view of an embodiment of a nozzle assembly in accordance with this disclosure, with the locking pin removed;

FIG. 2b shows a perspective cross-sectional view of an embodiment of a nozzle assembly in accordance with this disclosure, with the locking pin inserted;

FIG. 3 shows a cross-sectional view of the nozzle assembly of FIG. 2a taken through line 3-3;

FIG. 4a shows a cross-sectional view of a nozzle assembly in accordance with an embodiment of this disclosure; and

FIG. 4b shows a magnified view of the area around the locking pin in the nozzle assembly of FIG. 4a.

### DETAILED DESCRIPTION

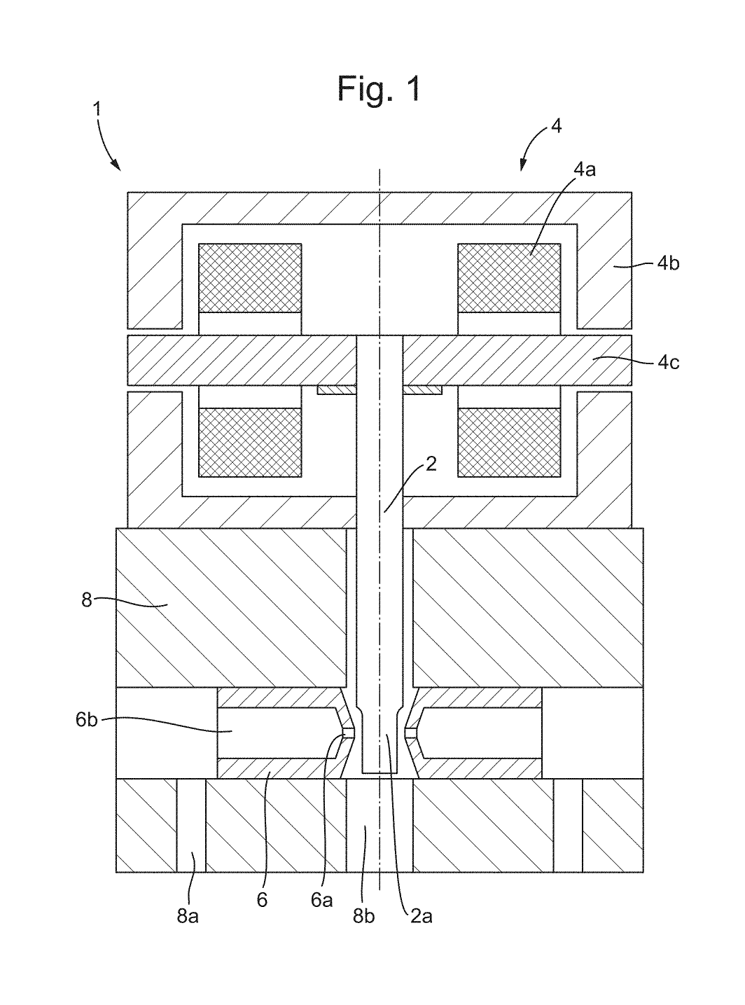

With reference to FIG. 1, a servo valve 1 is illustrated. Servo valve 1 comprises an electric motor 4, a flapper 2, nozzles 6 and a nozzle housing 8. The electric motor 4 comprises coils 4a, permanent magnets 4b and an armature 4c. The coils 4a are in electrical communication with an electrical supply (not shown) and when activated, interact with the permanent magnets 4b to create movement of the armature 4c, as is well-known in the art.

The flapper 2 is attached to the armature 4c, and is deflected by movement of the armature 4c. The nozzles 6 are housed within the nozzle housing 8 via an interference fit and each comprise a fluid outlet 6a and a fluid inlet 6b. The nozzle housing 8 also has a pair of ports 8a, which allow communication of fluid to the nozzles 6.

The flapper 2 comprises a blocking element 2a at an end thereof which interacts with the fluid outlets 6a of the nozzles 6 to provide metering of fluid from the fluid outlets 6a to a fluid port 8b in the nozzle housing 8, which allows communication of metered fluid from the nozzles 6 to an actuator (not shown). As is known in the art, the electric motor 4 is used to control deflection of the blocking element 2a and vary the fluid delivered to the actuator from the nozzles 6 as required.

Calibration of the servo valve 1 is achieved by adjusting the axial distance from the nozzle fluid outlet 6a to the flapper 2, by pulling or pushing the nozzles 6 axially (left or right) within the nozzle housing 8.

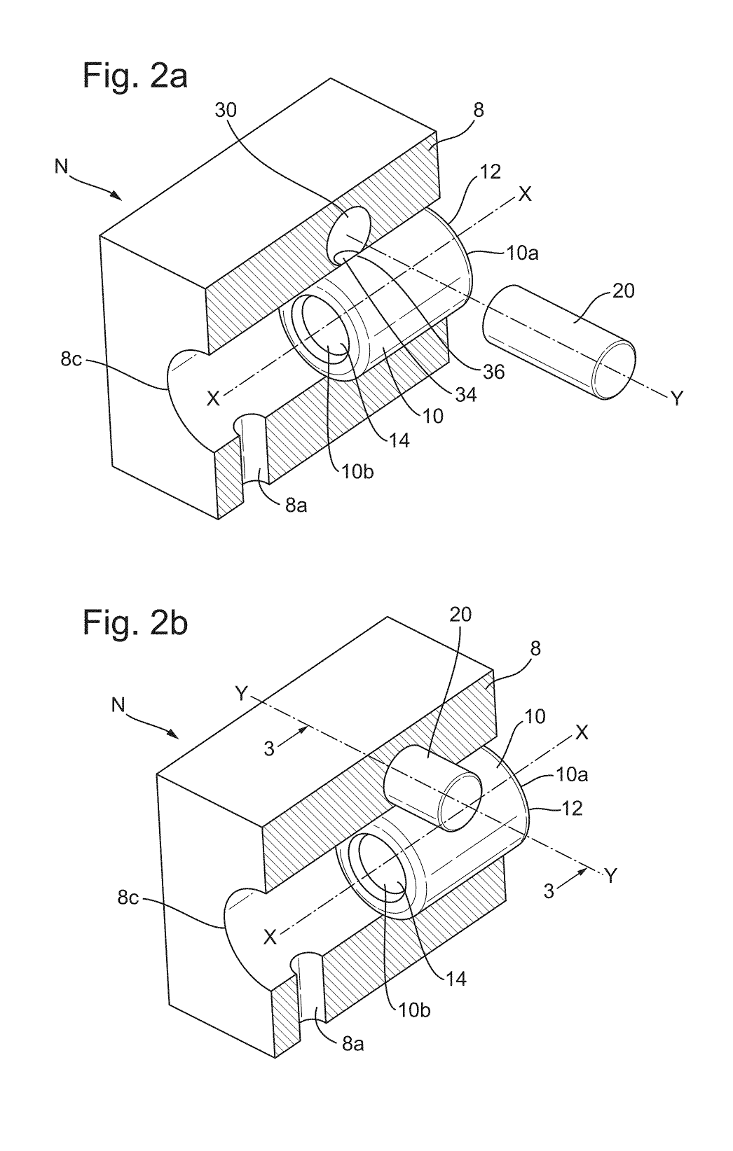

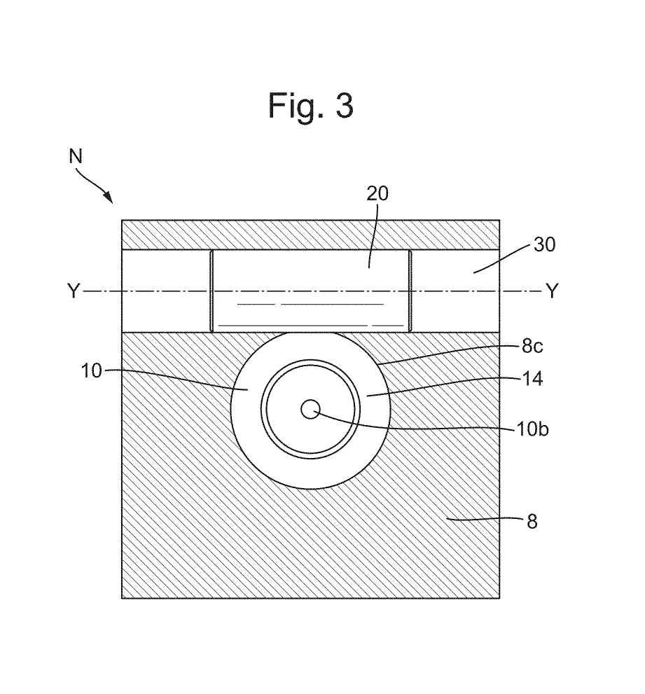

With reference to FIGS. 2a to 4b, a nozzle assembly N is illustrated for use in the servo valve of FIG. 1. The nozzle assembly N comprises a nozzle 10, a nozzle housing 8 and a locking pin 20. In fact, the nozzle housing 8 may be as shown in FIG. 1, receiving a pair of axially aligned nozzles 10.

The nozzle 10 defines a central passage 18 having a fluid outlet 10a at a first end 12 and a fluid inlet 10b at an opposed second end 14.

The nozzle housing 8 has a port 8a, which allows communication of fluid to the nozzle 10, a nozzle receiving bore 8c for receiving nozzle 10, and a locking pin receiving bore 30 for receiving the locking pin 20. The nozzle receiving bore 8c has a longitudinal axis X-X which in this embodiment is coaxial with the longitudinal axis of the nozzle 6.

The locking pin receiving bore 30 has a central longitudinal axis Y-Y which is perpendicular to the axis X-X of the nozzle receiving bore 8c. The locking pin receiving bore 30 intersects the nozzle receiving bore 8c such that an aperture 34 is formed between the locking pin receiving bore 30 and the nozzle receiving bore 8c.

The locking pin receiving bore 20 is, in this embodiment, arranged towards the inlet 14 of the nozzle 10. However, the axial position of the locking pin receiving bore 20 may be different in other embodiments.

In this embodiment, the locking pin receiving bore 30 and the nozzle receiving bore 8c are cylindrical in shape and circular in cross section, so that they may easily be formed by machining, for example drilling. However, this is not essential to the nozzle assembly construction and the respective bores 8c, 30 may be non-circular in cross section, for example square or rectangular in cross section. In addition, the locking pin receiving bore 30 at least need not be cylindrical and could have some other shape, for example a tapering shape or a rectangular prismatic shape.

In this embodiment, the nozzle 10 and locking pin 20 are also circular in cross section and have a complementary cylindrical shape to that of the nozzle receiving bore 8c and locking pin receiving bore 30 respectively. Of course if these bores 8c, 30 have a different shape from that shown, the nozzle 8 and locking pin 20 may have a different shape as well, for example complementary to the bore shapes.

In the embodiment illustrated, the locking pin receiving bore 30 is a through bore. This may be advantageous in that it allows the locking pin 20 to be accessible from both its ends which may facilitate its insertion or removal. However, this is not essential and the locking pin receiving bore 30 may, in other embodiments, be a blind bore, allowing access to just one end of the locking pin 20. In such an arrangement, the locking pin 20 may be provided with a suitable coupling at that end for the attachment of a tool for insertion or withdrawal of the locking pin 20 from the bore 30.

Also in the illustrated embodiment, the locking pin 20 is received completely within the locking pin receiving bore 30. Again this is not essential and the pin may project at one or more ends from the locking pin receiving bore 30. In one embodiment, for example, the locking pin 20 may be a push rod attached to a suitable actuator.

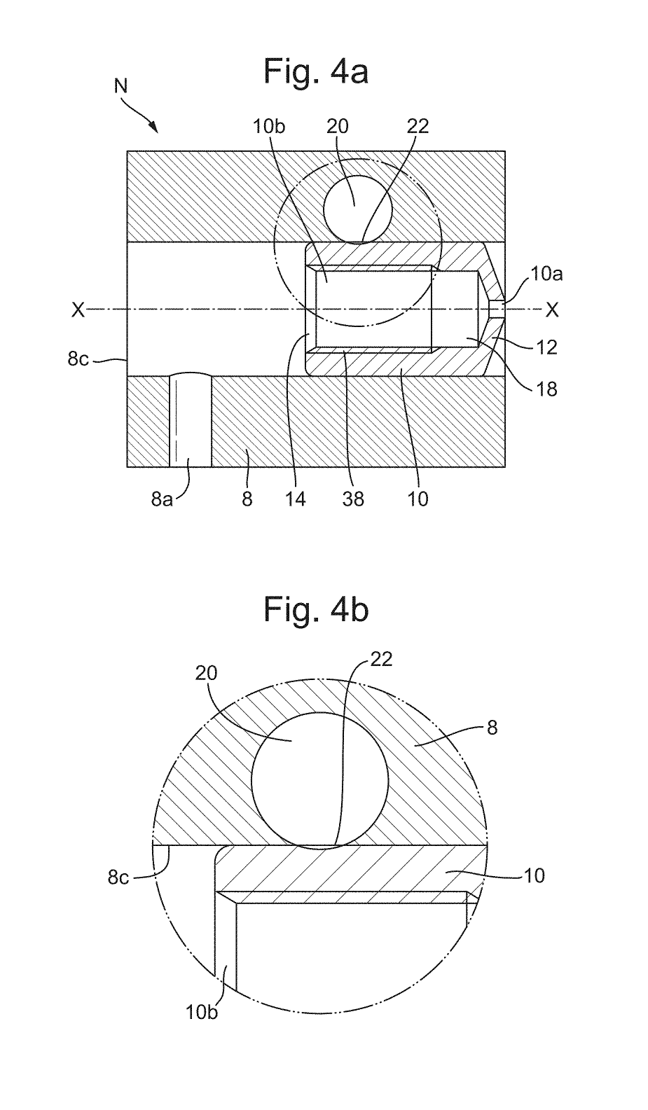

To facilitate calibration, the nozzle 10 may further comprise a threaded portion 38 on end 14 that can be removably secured to a calibration tool (not shown). The calibration tool may be a rod that can be threadably secured to the threaded portion 38 to allow the As illustrated in FIGS. 4a and 4b, the intersection of the nozzle receiving bore 8c and the locking pin receiving bore 30 allows a portion 22 of the locking pin 20 to protrude through the aperture 34 so as to engage and interfere with a circumferential surface 36 of the nozzle 10 and thereby lock the nozzle 10 in position within the nozzle receiving bore 8c.

Installation and calibration of the nozzle 10 will now be described.

The nozzle 10 is firstly “loosely” interference fitted within housing 8, such that nozzle 10 is relatively easily moveable along the longitudinal axis X-X during calibration, but at the same time still provides a leak-proof seal around the nozzle 10 during calibration. The nozzle 10 is moved to its desired axial position in the nozzle receiving bore 8c, for example using a calibration tool as described above.

The locking pin 20 is received in the locking pin receiving bore 30 with a loose or close fit so that it may be moved along the axis Y-Y of the locking pin receiving bore 30. In other embodiments, the locking pin 20 could also be interference fit within receiving bore 30. In an initial position, the locking pin 20 is retracted relative to the aperture 34, but when the nozzle has been moved to its desired axial position, it is moved along the axis Y-Y to enter the aperture 34 and engage and interfere with the circumferential surface 36 of the nozzle 10. The movement of the locking pin should advantageously be purely translational and not rotational since a rotational movement may impart a force to the nozzle 10 with a component along the axis X-X, which could lead to unwanted axial movement of the nozzle 10. The arrangement of the axis Y-Y perpendicular to the axis X-X ensures that translational movement of the pin will not induce an axial force on the nozzle 10.

The interference of the locking pin 20 with the nozzle 10 firmly locks the nozzle 10 in position. In effect it provides an additional frictional force between the nozzle 10 and the nozzle housing 8. In this way, in embodiments of the disclosure, the degree of interference between the nozzle 10 and the nozzle housing 8 can be reduced compared to a prior art nozzle, thereby facilitating calibration but still ensuring sufficient resistance to movement of the nozzle 10 at elevated temperatures.

It may also mean that the dimensional tolerances between the nozzle 10 and nozzle housing 8 may be reduced compared to prior art nozzles, possibly avoiding the need for grinding of the circumferential surface 36 of the nozzle 10 and burnishing of the nozzle receiving bore 8c of the nozzle housing 8. This may reduce the cost of manufacturing the nozzle assembly N.

The described embodiment may also facilitate refurbishment or repair of the nozzle assembly N, allowing for easier removal of the nozzle 10 from the nozzle housing 8.

Although the figures and the accompanying description describe particular embodiments and examples, it is to be understood that the scope of this disclosure is not to be limited to such specific embodiments, and is, instead, to be determined by the following claims.

1. A nozzle assembly (N) comprising:
a nozzle;
a nozzle housing having a nozzle receiving bore having a longitudinal axis (X-X), the nozzle being received within the nozzle receiving bore;
a locking pin receiving bore having a longitudinal axis (Y-Y) that is perpendicular to the nozzle housing axis (X-X), the locking pin receiving bore intersecting the nozzle receiving bore, whereby an aperture is formed between the locking pin receiving bore and the nozzle receiving bore;
a locking pin received in the locking pin receiving bore, a portion of the locking pin protruding through the aperture and into the nozzle receiving bore so as to engage and interfere with a circumferential portion of the nozzle.

2. A nozzle assembly as claimed in claim 1, wherein the nozzle is received with an interference fit within the nozzle receiving bore.

3. A nozzle assembly as claimed in claim 1, wherein the locking pin is received with a close or loose fit in the locking pin receiving bore.

4. A nozzle assembly as claimed in claim 1, wherein the nozzle receiving bore is cylindrical.

5. A nozzle assembly as claimed in claim 1, wherein the locking pin receiving bore is cylindrical.

6. A nozzle assembly as claimed in claim 1, wherein the locking pin receiving bore is a through bore.

7. A nozzle assembly as claimed in claim 1, wherein the nozzle receiving bore and/or the locking pin receiving bore are circular in cross section.

8. A nozzle assembly as claimed in claim 1, wherein the nozzle and/or the locking pin are circular in cross section.

9. A nozzle assembly as claimed in claim 1, wherein the nozzle is provided with a threaded connection at one end for connection to a calibration tool.

10. A nozzle assembly as claimed in claim 1, wherein the nozzle receiving bore receives a pair of opposed nozzles.

11. A servo valve comprising a nozzle assembly as claimed in claim 1.

12. A method of assembling a nozzle assembly comprising:
providing a nozzle housing having a nozzle receiving bore having a longitudinal axis (X-X) and a locking pin receiving bore having a longitudinal axis (Y-Y) perpendicular to the longitudinal axis (X-X) of the nozzle receiving bore and intersecting the nozzle receiving bore, whereby an aperture is formed between the locking pin receiving bore and the nozzle receiving bore;
inserting a nozzle into the nozzle receiving bore; and
inserting a locking pin into the locking pin receiving bore such that a portion of the locking pin protrudes through the aperture and presses onto a circumferential portion of the nozzle to lock the nozzle in position within the nozzle receiving bore.

13. A method as claimed in claim 12, wherein the nozzle is received in the nozzle receiving bore with an interference fit.

14. A method as claimed in claim 12, wherein the nozzle is inserted or moved in the nozzle receiving bore by a tool engaging an end of the nozzle.

15. A method of calibrating a nozzle assembly which comprises a nozzle housing having a nozzle receiving bore having a longitudinal axis X-X and a locking pin receiving bore having an axis (Y-Y) perpendicular to the axis (X-X) of the nozzle receiving bore and intersecting the nozzle receiving bore, whereby an aperture is formed between the locking pin receiving bore and the nozzle receiving bore; the method comprising:
moving a nozzle in the nozzle receiving bore to a desired axial position within the nozzle receiving bore; and
inserting a locking pin into the locking pin receiving bore such that a portion of the locking pin protrudes through the aperture and presses onto a circumferential portion of the nozzle to lock the nozzle in the desired axial position within the nozzle receiving bore.

16. A method as claimed in claim 15, wherein the nozzle is received in the nozzle receiving bore with an interference fit.

17. A method as claimed in claim 15, wherein the nozzle is inserted or moved in the nozzle receiving bore by a tool engaging an end of the nozzle.
